(19) United States
(12) Patent Application Publication
(10) Pub. No.: US 2023/0171403 A1
(43) Pub. Date: Jun. 1, 2023

(54) Methods and Apparatuses of Gaussian Elimination in Video Encoding System

(71) Applicant: MEDIATEK INC., Hsinchu City (TW)

(72) Inventors: Shih-Chun CHIU, Hsinchu City (TW); Tzu-Der CHUANG, Hsinchu City (TW); Ching-Yeh CHEN, Hsinchu City (TW); Chun-Chia CHEN, Hsinchu City (TW); Chih-Wei HSU, Hsinchu City (TW); Yu-Wen HUANG, Hsinchu City (TW)

(21) Appl. No.: 17/702,372

(22) Filed: Mar. 23, 2022

Related U.S. Application Data
(60) Provisional application No. 63/280,172, filed on Nov. 17, 2021.

(51) Int. Cl. H04N 19/117; H04N 19/82; H04N 19/176; H04N 19/174

(52) U.S. Cl. CPC H04N 19/117; H04N 19/82; H04N 19/174; H04N 19/176

(57) ABSTRACT

Video encoding methods and apparatuses include collecting statistics data, determining a matrix and vector representing a set of linear equations, solving the matrix and vector by a novel Gaussian elimination method to derive optimal parameter adjustments for an affine mode or adaptive loop filter coefficients, and encoding the current block by the affine mode or encoding one or more blocks by applying ALF filtering. Embodiments of the novel Gaussian elimination method reduce the critical path of entry operations in each row elimination step from one reciprocal, two multiplication, and one addition operations to one reciprocal, one multiplication, and one addition operations, or one multiplication and one addition operations.

### CROSS REFERENCE TO RELATED APPLICATIONS

The present invention claims priority to U.S. Provisional Pat. Application, Serial No. 63/280,172, filed on Nov. 17, 2021, entitled “Gaussian Elimination Methods”. The U.S. Provisional Pat. Application is hereby incorporated by reference in its entirety.

### FIELD OF THE INVENTION

The present invention relates to video data processing methods and apparatuses for video encoding. In particular, the present invention relates to apply Gaussian elimination to solve linear equations in a video encoding system.

### BACKGROUND AND RELATED ART

The Versatile Video Coding (VVC) standard is the latest video coding standard developed by the Joint Collaborative Team on Video Coding (JCT-VC) group of video coding experts from ITU-T Study Group. The VVC standard inherited former High Efficiency Video Coding (HEVC) standard which relies on a block-based coding structure, where each video picture contains one or a collection of slices and each slice is divided into an integer number of Coding Tree Units (CTUs). The individual CTUs in a slice are processed according to a raster scanning order. Each CTU is further recursively divided into one or more Coding Units (CUs) to adapt to various local motion and texture characteristics. The prediction decision is made at the CU level, where each CU is either coded by inter picture prediction or intra picture prediction. A specified prediction process is employed to predict the values of associated pixel samples inside the CU. After obtaining a residual signal generated by the prediction process, residual data of the residual signal belong to a CU is then transformed into transform coefficients for compact data representation. These transform coefficients are quantized and conveyed to the decoder. The terms Coding Tree Block (CTB) and Coding block (CB) are defined to specify two-dimensional sample array of one color component associated with the CTU and CU respectively. For example, a CTU consists of one luminance (luma, Y) CTB, two chrominance (chroma, Cb and Cr) CTBs, and its associated syntax elements.

Affine motion compensation utilizes an affine model to describe two-dimensional block rotations, as well as two-dimensional deformations of squares or rectangles into parallelogram. A 6-parameter initial affine model is shown in Equation (1).

$$x = {\text{Ax}}_{0} + {\text{By}}_{0} + \text{C} ;$$

$$\text{y} \text{=} {\text{Dx}}_{0} + {\text{Ey}}_{0} + \text{F} .$$

For each pixel (x,y) in the area of interest, a motion vector for this pixel is A′ ― A = (a0+(a1-1)*x+a2*y, b0+b1 *x+(b2-1)*y). The motion vector for each pixel is location dependent. In this affine model, if motion vectors of three different locations are known, the above six parameters in Equation (1) can be solved. Each location with a known motion vector is referred to as a control point. This six-parameter affine model corresponds to a three-control-point model. Assume the six parameters are changed from A, B, C, D, E, and F to (A+a, B+b, C+c, D+d, E+e, and F+f), the new affine model becomes:

$$\text{x} ′ = \left(A + a\right) {\text{x}}_{0} + \left(\text{B} + \text{b}\right) {\text{y}}_{0} + \left(\text{C} + \text{c}\right) = \text{x} + {\text{ax}}_{0} + {\text{by}}_{0} + \text{c} ;$$

$$\text{y} ′ = \left(\text{D+d}\right) {\text{x}}_{\text{0}} + \left(\text{E+e}\right) {\text{y}}_{0} + \left(\text{F+f}\right) = \text{y} + \text{dx} 0 + \text{ey} 0 + \text{f} .$$

In affine Control Point Motion Vector (CPMV) refinement, the model parameter adjustments (a, b, c, d, e, f) in the new affine model are refined to get a smaller distortion. In Equation (3), B is a current block, Org is the original values, I is the prediction values, and E is the distortion before the refinement.

$$\text{MSE=} \sum {}_{\left({x}_{0} , {y}_{0}\right) ∈ B} {\left‖O r g \left({x}_{0} , {y}_{0}\right) - I \left(x ′ , y ′\right)\right‖}^{2}$$

$$= \sum {}_{\text{B}} {\left‖\text{Org} \left({x}_{0} , {y}_{0}\right) - \text{I} \left(\text{x} + {\text{ax}}_{0} + {\text{by}}_{0} + \text{c,} \text{y} + {\text{dx}}_{0} + {\text{ey}}_{0} + \text{f}\right)\right‖}^{2}$$

$$= \sum {}_{B} {\left‖O r g \left(x , y\right) - \left(I \left(x , y\right) + I {′}_{x} \left(x , y\right) \left(a x + b y + c\right) + I {′}_{y} \left(x , y\right) \left(d x + e y + f\right)\right)\right‖}^{2}$$

$$= \sum {}_{\text{B}} {\left‖\text{E} - \left({\text{I′}}_{\text{x}} {\text{c + xI′}}_{\text{x}} {\text{a + I′}}_{\text{y}} {\text{f + xI′}}_{\text{y}} {\text{d + yI′}}_{\text{x}} {\text{b + yI′}}_{\text{y}} \text{e}\right)\right‖}^{2} .$$

Let

$$\vec{m} = {\left[c a f d b e\right]}^{T}$$

, and

$$\vec{k} = {\left[{\text{I′}}_{\text{x}} {\text{xI′}}_{\text{x}} {\text{I′}}_{\text{y}} {\text{xI′}}_{\text{y}} {\text{yI′}}_{\text{x}} {\text{yI′}}_{\text{ye}} \text{e}\right]}^{\text{T}}$$

, the gradient of Mean Square Error (MSE) with respect to m̅ is derived by Equation (4) in order to find the optimal parameter adjustment m̅ that leads to the lowest MSE.

$$\frac{\text{dMSE}}{\text{d} \vec{\text{m}}} \text{=} \frac{\text{d}}{\text{d} \vec{\text{m}}} \sum {}_{\text{B}} {\left‖\text{E} - {\vec{\text{k}}}^{\text{T}} \vec{\text{m}}\right‖}^{2} = 0 ⇒ \sum {}_{\text{B}} - 2 \vec{\text{k}} \left(\text{E} - {\vec{\text{k}}}^{\text{T}} \vec{\text{m}}\right) = 0 ⇒ \sum {}_{\text{B}} {\vec{\text{k}} \vec{\text{k}}}^{\text{T}} \vec{\text{m}} \text{=} \sum {}_{\text{B}} \vec{\text{k}} \text{E} \text{.}$$

In the encoding algorithm, the current distortion E and gradient information of the current predictor I’ₓ and I’_{y} in the current block B are collected.

$$\sum {}_{\text{B}} {\vec{\text{k}} \vec{\text{k}}}^{\text{T}} \vec{\text{m}} = \sum {}_{\text{B}} \vec{\text{k}} \text{E}$$

in Equation (4) can be solved using Gaussian elimination, where k̅k̅ is a 6x6 matrix, m̅ and k̅ are both 6-entry vectors, and E is a scalar.

In an implementation of affine motion compensation, Motion Vectors (MVs) of the three control points are signalled when the affine AMVP mode is used. At each control point location, the MV is predictively coded. Motion Vector Differences (MVDs) of these control points are then coded and transmitted.

Adaptive Loop Filter (ALF) is an effective in-loop filter for compression artifact reduction. ALF minimizes the MSE between original pixels and decoded pixels using Wiener-based adaptive filter coefficients. ALF reconstruction follows Equation (5):

$$r e c a f t e r A L F = r e c b e f o r e A L F + \sum {}_{c} \left({n}_{c} {f}_{c}\right) ;$$

where c denotes the number of coefficients, for example, 12 ALF coefficients for the luma component, 6 ALF coefficients for the chroma components, and 7 ALF coefficients for the Cross Component ALF (CCALF), n_{c} is the neighboring information derived from reconstruction before ALF and its neighboring samples, and f_{c} is ALF filter coefficients.

The distortion is defined as ssd = (org – (rec + Σ_{c}(n_{c}f_{c})))², and the total distortion is described in Equation (6):

$$\begin{matrix}\sum {}_{\text{p}} {\left({\text{org}}_{\text{p}} - {\text{rec}}_{\text{p}}\right)}^{2} - 2 \sum {}_{\text{c}} \left(\sum {}_{\text{p}} \left({\text{org}}_{\text{p}} - {\text{rec}}_{\text{p}}\right) {\text{n}}_{\text{pc}}\right) {\text{f}}_{\text{c}} + \sum {}_{\text{ci}} \sum {}_{\text{j}} \left(\sum {}_{\text{p}} {\text{n}}_{\text{pci}} {\text{n}}_{\text{pcj}}\right) {\text{f}}_{\text{i}} {\text{f}}_{\text{j}} \\ = \text{pixAcc} - 2 \sum {}_{\text{c}} \text{y} \left[\text{c}\right] {\text{f}}_{\text{c}} + \sum {}_{\text{ci}} \sum {}_{\text{cj}} \text{E} \left[\text{ci}\right] \left[\text{cj}\right] {\text{f}}_{\text{i}} {\text{f}}_{\text{j}} ;\end{matrix}$$

where pixAcc is the original distortion, which is constant for different filters, y[c] is the cross-correlation matrix, and E[ci][cj] is the auto-correlation matrix. These three types of statistics are sum over all samples and collected in advance.

The gradient of Sum of Square Difference (SSD) with respect to f_{c} is computed to derive optimal filter coefficients given the three types of statistics as shown in Equation (7).

$$\frac{\text{d} \left(\text{ssd}\right)}{\text{df}} = \frac{\text{d}}{\text{df}} \text{pixAcc} - 2 \sum {}_{\text{c}} \text{y} \left[\text{c}\right] {\text{f}}_{\text{c}} + \sum {}_{\text{ci}} \sum {}_{\text{cj}} \text{E} \left[\text{ci}\right] \left[\text{cj}\right] {\text{f}}_{\text{i}} {\text{f}}_{\text{j}} = 0 ⇒ - 2 \text{y} + \text{Ef} = 0 ⇒ \text{Ef} = \text{y} .$$

In the encoding algorithm, the statistics [pixAcc, y, E] in one slice are first collected, and the equation Ef = y is solved by Gaussian elimination to derive the optimal filter coefficients f. For example, for solving optimal ALF coefficients for chroma components, the auto-correlation matrix E is a 6x6 matrix and the cross correlation matrix y is a 6-entry vector.

### BRIEF SUMMARY OF THE INVENTION

In some embodiments of video encoding methods implemented in a video encoding system, Gaussian elimination for an affine mode or for ALF filtering is conducted by dividing row A by a common factor, dividing row B by another common factor, and adding row A to row B. The video encoding methods collect statistics data for deriving optimal parameter adjustments for a current block to be coded in the affine mode or collect statistics data for deriving optimal ALF coefficients for a current slice, determine a matrix and a vector representing a set of linear equations from the collected statistics data, generate a diagonal matrix and an updated vector by performing a row elimination step for each row of the matrix and vector to eliminate a corresponding entry of other rows, normalize entries in the updated vector by entries in the diagonal matrix to derive the optimal parameter adjustments or optimal ALF coefficients, and encode the current block by the affine mode according to the optimal parameter adjustments or encode one or more blocks by applying ALF filtering according to the optimal ALF coefficients. In a first row elimination step of Gaussian elimination according to some embodiments, each current row other than a first row is divided by a common factor corresponding to the current row, the first row is divided by a common factor corresponding to the first row, and the first row is then added to each current row. For example, in the first row elimination step according to some embodiments, entries except for the first row and first entries in each row are divided by the first entry of the corresponding row, then each intermediate entry is subtracted by the corresponding entry in the first row divided by a first entry in the first row. Other row elimination steps of Gaussian elimination are sequentially performed in a similar way as the first row elimination step. Each entry operation in each row elimination step may be realized by two reciprocal operations, two multiplication operations, and one addition operation, since the two reciprocal operations and the two multiplication operations may be done in parallel, the computing time required for each entry operation in each row elimination step is equal to the computing time of one reciprocal operation plus one multiplication operation plus one addition operation. In the first row elimination step, the common factor corresponding to the current row is a first entry of the current row and the common factor corresponding to the first row is a first entry of the first row according to an embodiment of the present invention. In a K^{th} row elimination step of Gaussian elimination according to some embodiments, each current row other than a K^{th} row is divided by a common factor corresponding to the current row, the K^{th} row is divided by a common factor corresponding to the K^{th} row, and the K^{th} row is then added to each current row. K is a positive integer number less than or equal to N. The common factor corresponding to the current row is a K^{th} entry of the current row and the common factor corresponding to the K^{th} row is a K^{th} entry of the K^{th} row.

In some embodiments of the present invention, the statistics data for deriving the optimal parameter adjustments comprises current distortion and gradient information of current predictors of the current block to be encoded in the affine mode. In some other embodiments of the present invention, the statistics data for deriving the optimal ALF coefficients comprises statistics of original distortions before applying ALF filtering, cross-correlation matrix and auto-correlation matrix of neighboring information of blocks in the current slice.

In an embodiment of applying Gaussian elimination for solving a four-parameter affine model in affine Control Point Motion Vector (CPMV) refinement, the matrix is a 4-rank matrix and the vector is a 4 entry vector. In another embodiment, Gaussian elimination is used to solve a six-parameter affine model in affine CPMV refinement, the matrix is a 6-rank matrix and the vector is a 6 entry vector. When Gaussian elimination of the present invention is used to derive optimal ALF coefficients for a luminance (luma) component, the matrix is a 12 rank matrix and the vector is a 12 entry vector for solving twelve linear equations. The matrix is a 6 rank matrix and the vector is a 6 entry vector when Gaussian elimination is used to derive optimal ALF coefficients for chrominance (chroma) components, and the matrix is a 7 rank matrix and the vector is a 7 entry vector when Gaussian elimination is used to derive optimal ALF coefficients for a Cross Component Adaptive Loop Filter (CCALF).

In some other embodiments of the present invention, video encoding methods of processing blocks by an affine mode or applying ALF filtering using Gaussian elimination in a video encoding system are conducted by multiplying row A by a common factor, multiplying row B by another common factor, and adding row A and row B. In a first row elimination step of Gaussian elimination, each current row other than the first row is multiplied by a common factor corresponding to the first row, the first row is multiplied by a common factor corresponding to the current row, and the first row is then added to each current row. For example, in the first row elimination step, entries except for the first row and first entries in each row are multiplied by a first entry of the first row, then each intermediate entry is subtracted by a multiple of the first entry of the corresponding row and corresponding entry in the first row. Other row elimination steps of Gaussian elimination are sequentially performed in a similar way as the first row elimination step. Each entry operation may be realized by two multiplication operations and one addition operation, and the computing time required for each entry operation is equal to the time of one multiplication operation plus one addition operation as the two multiplication operations can be done in parallel. The common factor corresponding to the first row is a first entry of the first row and the common factor corresponding to the current row is a first entry of the current row.

In some embodiments of Gaussian elimination, each row elimination step further comprises multiplying each row by a normalized factor before adding the rows. For example, in the first row elimination step, entries except for the first row and first entries in each row are multiplied by a first entry of the first row and normalized by the normalized factor, and then each intermediate entry is subtracted by a normalized multiple of the first entry of the corresponding row and corresponding entry in the first row. The normalized factor is a power of 2. Each entry is a fixed-point data type in an embodiment, thus multiplying each current row or first row by the normalized factor is realized by a bit shifting operation. In another embodiment, each entry is a floating-point data type, multiplying each current row or first row by the normalized factor is realized by an integer addition operation. In this embodiment, an exponent part e of an entry is an index of the normalized factor, that is the normalized factor is equal to 2^{e}. for example, the entry is a first entry of the first row.

Aspects of the disclosure further provide an apparatus for the video encoding system encoding video data by collecting statistics data for deriving optimal parameter adjustments for a current block to be encoded in an affine mode or collecting statistics data for deriving optimal ALF coefficients for a current slice, determining a matrix and vector representing a set of linear equations from the collected statistics data, generating a diagonal matrix and an updated vector by performing a row elimination step for each row of the matrix and vector to eliminate a corresponding entry of other rows, normalizing entries in the updated vector by entries in the diagonal matrix to derive the optimal parameter adjustments or optimal ALF coefficients, and encoding the current block by the affine mode according to the optimal parameter adjustments or encoding one or more blocks by applying ALF filtering according to the optimal ALF coefficients. In a first row elimination step of Gaussian elimination according to some embodiments, each current row other than the first row is multiplied by a common factor corresponding to the first row, the first row is multiplied by a common factor corresponding to the current row, and the first row is then added to each current row. In some other embodiments, each current row other than the first row is multiplied by a common factor corresponding to the first row and the first row is multiplied by a common factor corresponding to the current row, and each current row is then added to the first row. Other aspects and features of the invention will become apparent to those with ordinary skill in the art upon review of the following descriptions of specific embodiments.

### BRIEF DESCRIPTION OF THE DRAWINGS

Various embodiments of this disclosure that are proposed as examples will be described in detail with reference to the following figures, wherein like numerals reference like elements, and wherein:

FIG. 1 illustrates before and after applying Gaussian elimination to a 6×6 matrix and 6 entry vector.

FIG. 2 shows entry operations for the 6×6 matrix and 6 entry vector of FIG. 1 executed in the first row elimination step of the Gaussian elimination method.

FIG. 3 shows entry operations for the 6×6 matrix and 6 entry vector of FIG. 1 executed in the first row elimination step of a first embodiment of novel Gaussian elimination methods.

FIG. 4 shows entry operations for the 6×6 matrix and 6 entry vector of FIG. 1 executed in the first row elimination step of a second embodiment of novel Gaussian elimination methods.

FIG. 5 shows entry operations for the 6×6 matrix and 6 entry vector of FIG. 1 executed in the first row elimination step of a third embodiment of novel Gaussian elimination methods.

FIG. 6 shows entry operations for the 6×6 matrix and 6 entry vector of FIG. 1 executed in the first row elimination step of a fourth embodiment of novel Gaussian elimination methods.

FIG. 7 is a flowchart illustrating some embodiments of the present invention for performing a novel Gaussian elimination method in an affine mode or ALF filtering.

FIG. 8 illustrates an exemplary system block diagram for a video encoding system incorporating the novel Gaussian elimination method according to embodiments of the present invention.

### DETAILED DESCRIPTION OF THE INVENTION

It will be readily understood that the components of the present invention, as generally described and illustrated in the figures herein, may be arranged and designed in a wide variety of different configurations. Thus, the following more detailed description of the embodiments of the systems and methods of the present invention, as represented in the figures, is not intended to limit the scope of the invention, as claimed, but is merely representative of selected embodiments of the invention.

Reference throughout this specification to “an embodiment”, “some embodiments”, or similar language means that a particular feature, structure, or characteristic described in connection with the embodiments may be included in at least one embodiment of the present invention. Thus, appearances of the phrases “in an embodiment” or “in some embodiments” in various places throughout this specification are not necessarily all referring to the same embodiment, these embodiments can be implemented individually or in conjunction with one or more other embodiments. Furthermore, the described features, structures, or characteristics may be combined in any suitable manner in one or more embodiments. One skilled in the relevant art will recognize, however, that the invention can be practiced without one or more of the specific details, or with other methods, components, etc. In other instances, well-known structures, or operations are not shown or described in detail to avoid obscuring aspects of the invention.

In the video encoding process, Gaussian elimination is used in affine Control Point Motion Vector (CPMV) refinement and ALF coefficient derivation to compute affine model parameters and ALF coefficients that minimizes the distortion of video encoding. For example, optimal control point MVs in a four-parameter affine model are derived by solving four linear equations, optimal control point MVs in a six-parameter affine model are derived by solving six linear equations, ALF coefficients for the luminance (luma) component are derived by solving twelve linear equations, ALF coefficients for the chrominance (chroma) components are derived by solving six linear equations, and ALF coefficients for the Cross Component Adaptive Loop Filter (CCALF) are derived by solving seven linear equations. The following descriptions only demonstrate the characteristic of the novel Gaussian elimination method used to solve six-parameter affine model in affine CPMV refinement or chroma ALF coefficients. The detailed descriptions of applying Gaussian elimination in deriving the four-parameter affine model, luma ALF coefficients, and CCALF coefficients are omitted for brevity.

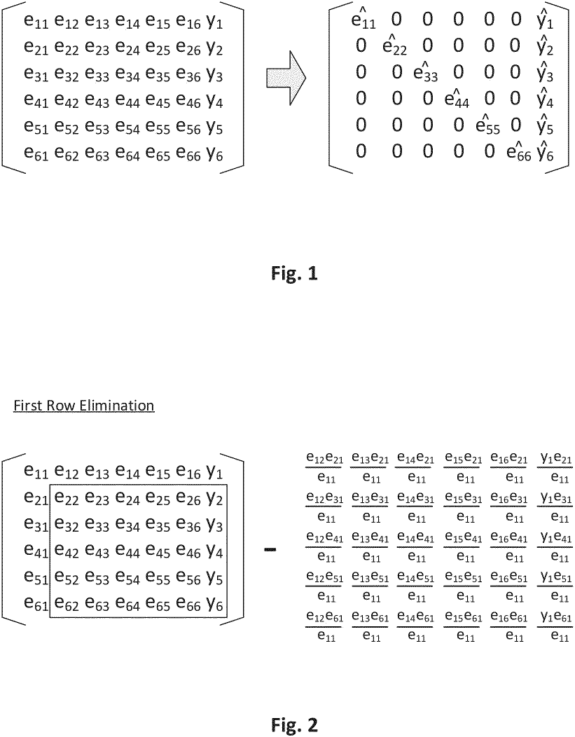

Gaussian Elimination The process of Gaussian elimination for a 6×6 matrix and a 6 entry vector involves seven steps: the first six steps are row elimination steps and the first step is normalization. FIG. 1 illustrates before and after applying Gaussian elimination to a 6×6 matrix and 6 entry vector, a matrix E and a vector Y becomes a diagonal matrix and an updated vector after applying Gaussian elimination. The first step of Gaussian elimination is referred to as the first row elimination step, where the first entries of second to sixth rows are eliminated using the first row, and the second step is the second row elimination step, where the second entries of rows other than the second row are eliminated using the second row. Similarly, the third entries of rows other than the third row are eliminated using the third row in the third row elimination step, the fourth entries of rows other than the fourth row are eliminated using the fourth row in the fourth row elimination step, the fifth entries of rows other than the fifth row are eliminated using the fifth row in the fifth row elimination step, and the sixth entries of rows other than the sixth row are eliminated using the sixth row in the sixth row elimination step. In the last step of normalization, x1 to x6 can be derived by:

$$\text{x1=} {\hat{\text{y}}}_{\text{1}} / {\hat{\text{e}}}_{\text{11}} \text{, x2=} {\hat{\text{y}}}_{\text{2}} / {\hat{\text{e}}}_{\text{22}} \text{, x3=} {\hat{\text{y}}}_{\text{3}} / {\hat{\text{e}}}_{\text{33}} \text{, x4=} {\hat{\text{y}}}_{\text{4}} / {\hat{\text{e}}}_{\text{44}} \text{, x5=} {\hat{\text{y}}}_{5} / {\hat{\text{e}}}_{55} \text{, x6=} {\hat{\text{y}}}_{6} / {\hat{\text{e}}}_{66} .$$

FIG. 2 shows the entry operation for each entry except for the entries in the first row or first column executed in the first row elimination step of the normal Gaussian elimination process. The first row elimination step is given as an example as the entry operations for other row elimination steps are similar to the entry operations in the first row elimination. Each entry operation in the normal first row elimination includes one multiplications, one division, and one subtraction. For example, the entry operation for the second entry in the second row in the first row elimination is shown in Equation (8), where the updated entry is equal to the original entry value (e₂₂) minus a multiple of the second entry value in the first row (e₁₂) and the first entry value in the second row (e₂₁) divided by the first entry value in the first row (e₁₁). In terms of hardware design, the critical path of each entry operation in the first row elimination step is one reciprocal, two multiplication, and one addition operations. Embodiments of the present invention simplify the entry operations of Gaussian elimination in each row elimination step.

$${e}_{22} \to {e}_{22} - {e}_{12} \frac{{e}_{21}}{{e}_{11}}$$

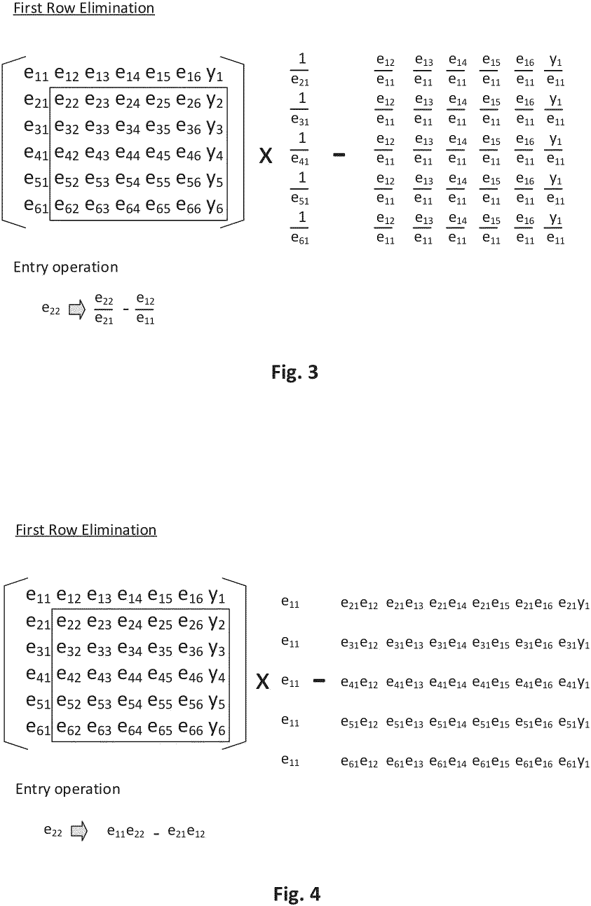

Novel Gaussian Elimination A first embodiment of the novel Gaussian elimination methods simplifies the entry operations in each row elimination step by first dividing other entries of each row by the corresponding first entry. FIG. 3 shows the entry operations executed in the first row elimination step of the Gaussian elimination process according to this embodiment of the present invention. In this embodiment, the entries except for the first row and the first entry in each row are divided by the first entry of the corresponding row, and then each of the intermediate entries is subtracted by the corresponding entry in the first row divided by the first entry in the first row. For example, the entry operation for the second entry in the second row is shown in Equation (9), where the updated entry is equal to the original entry value (e₂₂) divided by the first entry value in the second row (e₂₁) minus the second entry value in the first row (e₁₂) divided by the first entry value in the first row (e₁₁).

$${e}_{22} \to \frac{{e}_{22}}{{e}_{21}} - \frac{{e}_{12}}{{e}_{11}}$$

In the first row elimination step, each current row other than a first row is divided by a common factor corresponding to the current row, the first row is divided by a common factor corresponding to the first row, and the first row is then added to each current row. The common factor corresponding to the current row is a first entry of the current row and the common factor corresponding to the first row is a first entry of the first row. Other row elimination steps of Gaussian elimination are sequentially performed in a similar way as the first row elimination step. For example, in a K^{th} row elimination step according to an embodiment of the novel Gaussian elimination method, each current row other than a K^{th} row is divided by a common factor corresponding to the current row, the K^{th} row is divided by a common factor corresponding to the K^{th} row, and the K^{th} row is then added to each current row. K is a positive integer number less than or equal to N according to the embodiment of the present invention. The common factor corresponding to the current row is a K^{th} entry of the current row and the common factor corresponding to the K^{th} row is a K^{th} entry of the K^{th} row. In terms of hardware design, the critical path of each entry operation in each row elimination step according to the first embodiment becomes one reciprocal, one multiplication, and one addition operations. Each entry operation in each row elimination step is realized by two reciprocal operations, two multiplication operations, and one addition operation. The two reciprocal operations and the two multiplication operations can be done in parallel, so the computing time required for each entry operation is equal to a computing time of one reciprocal operation plus one multiplication operation plus one addition operation.

In a second embodiment of the novel Gaussian elimination methods, each entry operation in the row elimination steps is simplified by first multiplying entries other than the first row or first column by the first entry in the first row. FIG. 4 shows the entry operations executed in the first row elimination step of the Gaussian elimination process according to the second embodiment of the present invention. Each of the entries except for the first row and the first entry in each row is multiplied by the first entry of the first row, and then each of the intermediate entries is subtracted by a multiple of the first entry of the corresponding row and the corresponding entry in the first row. For example, the entry operation for the second entry in the second row is shown in Equation (10), where the updated entry is equal to the original entry value (e₂₂) multiplied by the first entry value in the first row (e₁₁) minus the multiple of the first entry value in the second row (e₂₁) and the second entry value in the first row (e₁₂). In a first row elimination step of Gaussian elimination, each current row other than the first row is multiplied by a common factor corresponding to the first row, the first row is multiplied by a common factor corresponding to the current row, and the first row is then added to each current row. The common factor corresponding to the first row is a first entry of the first row, and the common factor corresponding to the current row is a first entry of the current row in the first row elimination step. For example, in the first row elimination step, entries except for the first row and first entries in each row are multiplied by a first entry of the first row, then each intermediate entry is subtracted by a multiple of the first entry of the corresponding row and corresponding entry in the first row. Other row elimination steps of Gaussian elimination are sequentially performed in a similar way as the first row elimination step. In terms of hardware design, the critical path of each entry operation in each row elimination step according to the second embodiment is reduced from one reciprocal, one multiplication, and one addition operations to only one multiplication and one addition operations. Each entry operation is realized by two multiplication operations and one addition operation, and the computing time required for each entry operation is equal to a computing time of one multiplication operation and one addition operation as the two multiplication operations can be done in parallel.

$${e}_{22} \to {e}_{11} {e}_{22} - {e}_{21} {e}_{12}$$

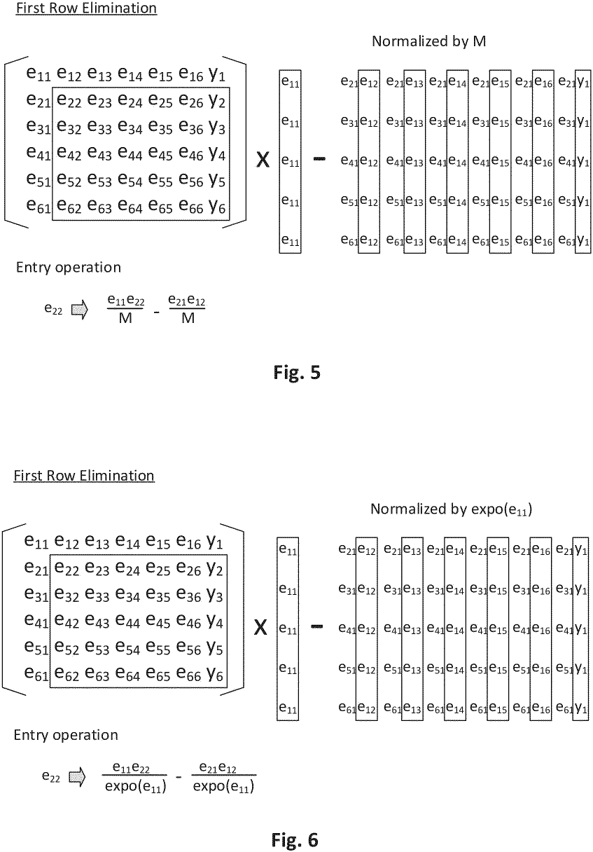

A third embodiment of the novel Gaussian elimination methods further improves the second embodiment by normalization (especially for the entries are in fixed-point representation). The products of the multiplications in Equation (10) may become too large so the third embodiment further divides each product by a normalization factor M. The normalization can be realized by bit shifting (especially for the case that each entry is a fixed-point data type). The normalization factor M is chosen to be a power of 2. FIG. 5 shows the entry operations executed in the first row elimination step of the Gaussian elimination process according to the third embodiment. Each of the entries except for the first row and the first entry in each row is multiplied by the first entry of the first row and normalized by M, and then each of the intermediate entries is subtracted by a normalized multiple of the first entry of the corresponding row and the corresponding entry in the first row. For example, the entry operation for the second entry in the second row is shown in Equation (11), where the updated entry is equal to the original entry value (e₂₂) multiplied by the first entry value in the first row (e₁₁), normalized by M, then minus the multiple of the first entry value in the second row (e₂₁) and the second entry value in the first row (e₁₂) normalized by M. M is chosen to be a power of 2 (especially for the case that each entry is a fixed-point data type) so a bit shift operation is employed for the normalization. Other row elimination steps of Gaussian elimination in this embodiment are sequentially performed in a similar way as the first row elimination step. In terms of hardware design, the critical path of each entry operation in each row elimination step according to the third embodiment becomes one multiplication, one addition, and one shifting operations.

$${e}_{22} \to \frac{{e}_{11} {e}_{22}}{M} - \frac{{e}_{21} {e}_{12}}{M}$$

A fourth embodiment is also an improved Gaussian elimination method based on the second embodiment (especially for the floating-point data type). The normalization factor M in the fourth embodiment is a power of 2, for example, M is equal to 2 to the power of an exponent part of the first entry in the first row, M = 2^(exponent of e₁₁) = expo(e₁₁). In some embodiments, each entry is in a floating point representation, where each entry includes a sign part, a exponent part, and a fraction part. The value of an entry is equal to (-1)^sign * fraction * 2^(exponent). The normalization can be realized by exponent subtraction, which is an integer addition operation. FIG. 6 shows the entry operations executed in the first row elimination step of the Gaussian elimination process according to the fourth embodiment. Each of the entries except for the first row and the first entry in each row is multiplied by the first entry of the first row and normalized by expo(e₁₁), and then each of the intermediate entries is subtracted by a multiple of the first entry of the corresponding row and the corresponding entry in the first row normalized by expo(e₁₁). For example, the entry operation for the second entry in the second row is shown in Equation (12), where the updated entry is equal to the original entry value (e₂₂) multiplied by the first entry value in the first row (e₁₁), normalized by expo(e₁₁), then minus the multiple of the first entry value in the second row (e₂₁) and the second entry value in the first row (e₁₂) normalized by expo(e₁₁). Other row elimination steps of Gaussian elimination in the fourth embodiment are sequentially performed in a similar way as the first row elimination step. Since the normalization factor is 2 to the power of an exponent part of an entry and the entries are in floating-point representation, normalization is realized by an exponent subtraction operation. In terms of hardware design, the critical path of each entry operation in each row elimination step according to the fourth embodiment becomes one integer addition, one multiplication and one addition.

$${e}_{22} \to \frac{{e}_{11} {e}_{22}}{e x p o \left({e}_{11}\right)} - \frac{{e}_{21} {e}_{12}}{e x p o \left({e}_{11}\right)}$$

Embodiments of the novel Gaussian elimination methods are capable of solving inverse matrices by hardware faster than the normal Gaussian elimination method. All row elimination steps of an N-rank matrix are completed in kN cycles if each entry operation requires k cycles. The row elimination steps in the Gaussian elimination process are data dependent so lower the number of cycles (k) for each entry operation is the only way to reduce the time required to solve the matrix. Various embodiments of the novel Gaussian elimination methods can be applied to solve the matrices for affine CPMV and ALF coefficients in video encoding to reduce the critical path of the entry operation, which leads to a lower k. For example, 500 MHz operation frequency only allows one floating-point multiplication operation and one floating-point addition operation in one cycle. The normal Gaussian elimination method needs 2 cycles to finish an entry operation (b-a*(c/d)) in the row elimination steps, resulting a total of 2N cycles for all the row elimination steps. The novel Gaussian elimination methods (b/c-a/d, b*d-a*c, b*norm(d)-a*norm(c)) only need 1 cycle per entry operation in the row elimination steps which reduces the number of cycles for all the row elimination steps from 2N to N.

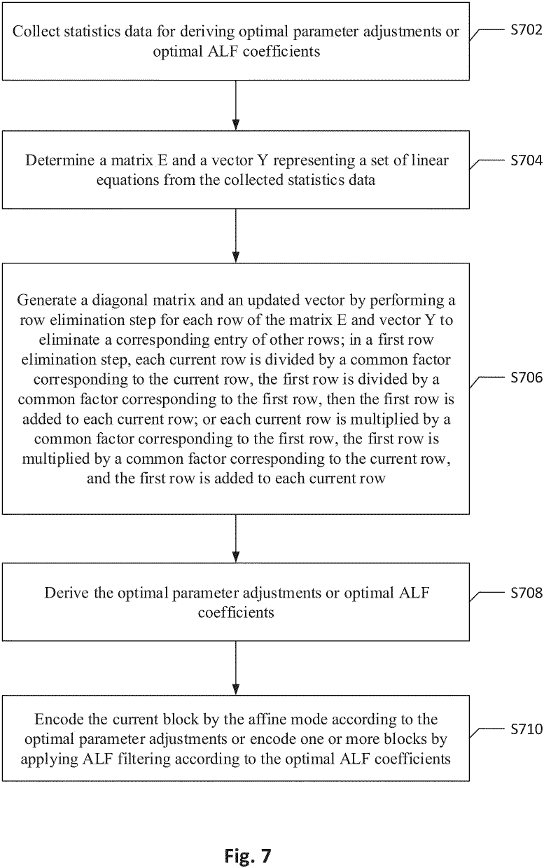

Representative Flowcharts for Exemplary Video Encoding System FIG. 7 is a flowchart illustrating implementing exemplary embodiments of the novel Gaussian elimination methods for encoding a current block by an affine mode or processing one or more blocks by ALF filtering. Statistics data for deriving optimal parameter adjustments for the current block to be encoded in the affine mode or statistic data for deriving optimal ALF coefficients for a current slice are collected by the video encoding system in step S702. In step S704, a matrix E and a vector Y representing a set of linear equations from the collected statistics data are determined to be solved by Gaussian elimination. A diagonal matrix and an updated vector are generated by performing a row elimination step for each row of the matrix E and vector Y to eliminate a corresponding entry of other rows in step S706. In a first row elimination step according to an embodiment of the novel Gaussian elimination methods, each current row other than a first row is divided by a common factor corresponding to the current row, the first row is divided by a common factor corresponding to the first row, then the first row (after division) is added to each current row (after division). For example, entries except for the first row and first entries in each row are divided by the first entry of the corresponding row, then each intermediate entry is subtracted by the corresponding entry in the first row divided by a first entry in the first row. Similar entry operations are performed in the remaining row elimination steps. The critical path for each entry operation in each row elimination step is one reciprocal operation, one multiplication operation, and one addition operation according to this embodiment. In a first row elimination step according to another embodiment of the novel Gaussian elimination methods, each current row other than a first row is multiplied by a common factor corresponding to the first row, the first row is multiplied by a common factor corresponding to the current row, and the first row (after multiplication) is added to each current row (after multiplication). For example, entries except for the first row and first entries in each row are multiplied by a first entry of the first row, then each intermediate entry is subtracted by a multiple of the first entry of the corresponding row and corresponding entry in the first row. In some other embodiments, each row elimination step further comprises multiplying each row by a normalized factor before adding the rows. For example, in the first row elimination step, entries except for the first row and first entries in each row are multiplied by a first entry of the first row and normalized by a normalized factor, and then each intermediate entry is subtracted by a normalized multiple of the first entry of the corresponding row and the corresponding entry in the first row. The normalized factor is selected as a power of 2 and normalizing is realized by a bit shifting operation for entries with a fixed-point data type, or normalizing is realized by an integer addition operation for entries with a floating-point data type. In step S708, the video encoding system normalizes entries in the updated vector by entries in the diagonal matrix to derive the optimal parameter adjustments for the current block or optimal ALF coefficients for the current slice. The video encoding system then encodes the current block by the affine mode according to the optimal parameter adjustments or encodes one or more blocks by applying ALF filtering according to the optimal ALF coefficients in step S710.

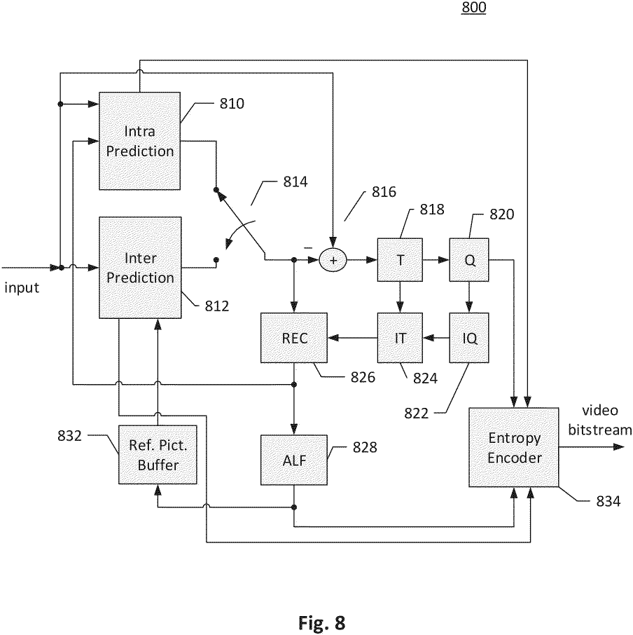

Representative System Block Diagrams FIG. 8 illustrates an exemplary system block diagram for a Video Encoder 800 implementing one or more embodiments associated with the novel Gaussian elimination methods in affine prediction or ALF filtering. Intra Prediction module 810 provides intra predictors based on reconstructed video data of a current picture. Inter Prediction module 812 performs Motion Estimation (ME) and Motion Compensation (MC) to provide predictors based on referencing video data from other picture or pictures. In an embodiment, when an affine mode is used to encode a current block, a novel Gaussian elimination method is used to solve linear equations to obtain optimal parameter adjustments of the affine model for predicting the current block. Either Intra Prediction module 810 or Inter Prediction module 812 supplies the selected predictor to Adder 816 to form residues. The residues of the current block are further processed by Transformation module (T) 818 followed by Quantization module (Q) 820. Quantization module 820 receives scaled transform coefficients of each transform block from Transformation module 818, and applies a quantization processing to generate a transformed and quantized residual signal. The transformed and quantized residual signal is then encoded by Entropy Encoder 830 to form a video bitstream. The video bitstream is then packed with side information. The transformed and quantized residual signal of the current block is processed by Inverse Quantization module (IQ) 822 and Inverse Transformation module (IT) 824 to recover the prediction residues. As shown in FIG. 8, the residues are recovered by adding back to the selected predictor at Reconstruction module (REC) 826 to produce reconstructed video data. The reconstructed video data may be stored in Reference Picture Buffer (Ref. Pict. Buffer) 832 and used for prediction of other pictures. The reconstructed video data from REC module 826 may be subject to various impairments due to the encoding processing, consequently, Adaptive Loop Filter (ALF) 828 is applied to the reconstructed video data before storing in the Reference Picture Buffer 832 to further enhance picture quality. According to an embodiment of the present invention, statistics data associated with a current slice are collected and optimal ALF coefficients are derived by a novel Gaussian elimination method. The critical path of entry operations in the novel Gaussian elimination method may be shorten compared to the critical path in the normal Gaussian elimination method, resulting a faster hardware for deriving optimal parameter adjustments for the affine model or optimal ALF coefficients. Syntax elements are provided to Entropy Encoder 830 for incorporation into the video bitstream.

Various components of Video Encoder 800 in FIG. 8 may be implemented by hardware components, one or more processors configured to execute program instructions stored in a memory, or a combination of hardware and processor. For example, a processor executes program instructions to perform row elimination steps in Gaussian elimination. The processor is equipped with a single or multiple processing cores. In some examples, the processor executes program instructions to perform functions in some components in Encoder 800, and the memory electrically coupled with the processor is used to store the program instructions, information corresponding to the reconstructed images of blocks, and/or intermediate data during the encoding process. The memory in some embodiment includes a non-transitory computer readable medium, such as a semiconductor or solid-state memory, a random access memory (RAM), a read-only memory (ROM), a hard disk, an optical disk, or other suitable storage medium. The memory may also be a combination of two or more of the non-transitory computer readable medium listed above.

Embodiments of the video data processing method performing a specific process on a current slice in a video encoding system may be implemented in a circuit integrated into a video compression chip or program code integrated into video compression software to perform the processing described above. For examples, scaling transform coefficient levels in a current transform block may be realized in program code to be executed on a computer processor, a Digital Signal Processor (DSP), a microprocessor, or field programmable gate array (FPGA). These processors can be configured to perform particular tasks according to the invention, by executing machine-readable software code or firmware code that defines the particular methods embodied by the invention. In some embodiments, a subtraction operation may be implemented using an addition operation. In some embodiments, a division operation may be implemented using a multiplication operation along with a reciprocal operation.

The invention may be embodied in other specific forms without departing from its spirit or essential characteristics. The described examples are to be considered in all respects only as illustrative and not restrictive. The scope of the invention is therefore, indicated by the appended claims rather than by the foregoing description. All changes which come within the meaning and range of equivalency of the claims are to be embraced within their scope.

1. A video encoding method of processing blocks by an affine mode or applying Adaptive Loop Filter (ALF) filtering using Gaussian elimination in a video encoding system, comprising:
collecting statistics data for deriving optimal parameter adjustments for a current block to be encoded in the affine mode or collecting statistics data for deriving optimal ALF coefficients for a current slice;
determining a matrix and a vector representing a set of linear equations from the collected statistics data, wherein the matrix is an N-rank matrix and the vector is an N entry vector;
generating a diagonal matrix and an updated vector by performing a row elimination step for each row of the matrix and vector to eliminate a corresponding entry of other rows, wherein in a first row elimination step, each current row other than a first row is divided by a common factor corresponding to the current row and the first row is divided by a common factor corresponding to the first row, or each current row other than the first row is multiplied by a common factor corresponding to the first row and the first row is multiplied by a common factor corresponding to the current row, and the first row is then added to each current row;
normalizing entries in the updated vector by entries in the diagonal matrix to derive the optimal parameter adjustments for the current block or optimal ALF coefficients for the current slice; and
encoding the current block by the affine mode according to the optimal parameter adjustments or encoding one or more blocks by applying ALF filtering according to the optimal ALF coefficients.

2. The method of claim 1, wherein the statistics data for deriving the optimal parameter adjustments for a current block to be encoded in the affine mode comprises current distortions and gradient information of current predictors of the current block.

3. The method of claim 1, wherein the statistics data for deriving the optimal ALF coefficients for a current slice comprises statistics of original distortions before applying ALF filtering, cross-correlation matrix and auto-correlation matrix of neighboring information of blocks in the current slice.

4. The method of claim 1, wherein in the first row elimination step, entries except for the first row and first entries in each row are divided by the first entry of the corresponding row, then each intermediate entry is subtracted by the corresponding entry in the first row divided by a first entry in the first row.

5. The method of claim 4, wherein a critical path for computing each entry operation in each row elimination step is one reciprocal operation, one multiplication operation, plus one addition operation.

6. The method of claim 1, wherein in the first row elimination step, the common factor corresponding to the current row is a first entry of the current row and the common factor corresponding to the first row is a first entry of the first row.

7. The method of claim 1, wherein N is equal to 4 for solving four linear equations associated with a four-parameter affine model in affine Control Point Motion Vector (CPMV) refinement, or N is equal to 6 for solving six linear equations associated with a six-parameter affine model in affine CPMV refinement.

8. The method of claim 1, wherein N is equal to 12 for solving twelve linear equations associated with ALF coefficients for a luminance component, or N is equal to 6 for solving six linear equations associated with ALF coefficients for chrominance components, or N is equal to 7 for solving seven linear equations associated with ALF coefficients for a Cross Component Adaptive Loop Filter (CCALF).

9. The method of claim 1, wherein in the first row elimination step, entries except for the first row and first entries in each row are multiplied by a first entry of the first row, then each intermediate entry is subtracted by a multiple of the first entry of the corresponding row and corresponding entry in the first row.

10. The method of claim 9, wherein a critical path for computing each entry operation is one multiplication operation plus one addition operation.

11. The method of claim 1, wherein each row elimination step further comprises multiplying each row by a normalized factor before adding the rows.

12. The method of claim 11, wherein in the first row elimination step, entries except for the first row and first entries in each row are multiplied by a first entry of the first row and normalized by the normalized factor, and then each intermediate entry is subtracted by a normalized multiple of the first entry of the corresponding row and corresponding entry in the first row.

13. The method of claim 11, wherein the normalized factor is a power of 2, and multiplying each current row or first row by the normalized factor is realized by a bit shifting operation.

14. The method of claim 11, wherein the normalized factor is a power of 2, and multiplying each current row or first row by the normalized factor is realized by an integer addition operation.

15. The method of claim 14, wherein the normalized factor is 2 to the power of an exponent part of a first entry of the first row.

16. An apparatus for processing blocks in an affine mode or applying Adaptive Loop Filter (ALF) filtering using Gaussian elimination in a video encoding system, the apparatus comprising one or more electronic circuits configured for:
collecting statistics data for deriving optimal parameter adjustments for a current block to be encoded in the affine mode or collecting statistics data for deriving optimal ALF coefficients for a current slice;
determining a matrix and a vector representing a set of linear equations from the collected statistics data, wherein the matrix is an N-rank matrix and the vector is an N entry vector;
generating a diagonal matrix and an updated vector by performing a row elimination step for each row of the matrix and vector to eliminate a corresponding entry of other rows, wherein in a first row elimination step, each current row other than a first row is divided by a common factor corresponding to the current row and the first row is divided by a common factor corresponding to the first row, or each current row other than the first row is multiplied by a common factor corresponding to the first row and the first row is multiplied by a common factor corresponding to the current row, and the first row is then added to each current row;
normalizing entries in the updated vector by entries in the diagonal matrix to derive the optimal parameter adjustments for the current block or optimal ALF coefficients for the current slice; and
encoding the current block by the affine mode according to the optimal parameter adjustments or encoding one or more blocks by applying ALF filtering according to the optimal ALF coefficients.
